(19) United States
(12) Patent Application Publication
(10) Pub. No.: US 2010/0327080 A1
(43) Pub. Date: Dec. 30, 2010

(54) SPRAY HEAD COUPLER

(76) Inventors: Kia Toon Wong, Shanghai (CN); Yuzhai Lin, Tianjin (CN)

Correspondence Address: LANIER FORD SHAVER & PAYNE P.C., P O BOX 2087, HUNTSVILLE, AL, 35804-2087, US

(21) Appl. No.: 12/741,180

(22) PCT Filed: Oct. 31, 2008
(86) PCT No.: PCT/SG2008/000417

§ 371 Date: Aug. 17, 2010

(30) Foreign Application Priority Data
Nov. 2, 2007 (CN) 200720097445.1

(51) Int. Cl. B05B 1/28

(52) U.S. Cl. 239/337

(57) ABSTRACT

Embodiments of the present invention provide a spray head coupler for concentrating an aerosol spray from a nozzle of an aerosol container. The spray head coupler may comprise a flexible collar capable of being coupled to the nozzle and adapted to hold a hollow tube for directing the aerosol spray such that the hollow tube is held in place when the aerosol spray is expelled from said aerosol container.

### FIELD OF INVENTION

Embodiments of the present invention provide a special spray head coupler for an aerosol spray can.

### BACKGROUND

Various types of aerosol spray cans are used in our daily lives. The various aerosols in these cans may include, by way of example and not limitation, insecticides, cleaning agents, vehicle degreasers, anti-rust products etc. Occasionally, a user may wish to spray the aerosol into hard-to-reach locations, places where the can or the hand holding it will not fit, or into a particular confined area. The standard spray nozzle provides for a generally wide spray pattern. This makes spraying the aerosol into those places very difficult.

Attempts have been made to correct this deficiency using a single long fine piece of tubing that can be inserted into the nozzle. For example, FIGS. 1A and 1B illustrate one embodiment of a prior art system 10 that has been used to solve the above problem. As shown, the system 10 includes a top portion 12 of an aerosol can (not shown). The top portion 12 includes an aerosol spray nozzle 14 having at least one opening 16. The opening 16 may further include an ejection port 18 from which an aerosol spray 20 may be ejected from the aerosol can. A single long fine piece of tubing 22 may be inserted into the opening 16 of the nozzle 12. In this embodiment of the prior art, the tubing 22 is held in place by friction.

Unfortunately, the great expulsive force exerted by the nozzle 14 during spraying often causes the long fine tubing 22 to detach from the opening 16 in the nozzle 14. This allows the aerosol spray 20 to then be deposited in undesired locations.

It would therefore be a great improvement in the art if a device could be developed that would help to eliminate one or more of the above-mentioned problems.

### SUMMARY

Embodiments of the present invention provide a spray head coupler, that may be installed anytime, and is easy to operate. The spray head coupler can be secured to the nozzle such that the pressure of the aerosol spray does not eject the long fine tubing from the nozzle. This allows the aerosol to be sprayed accurately at the designated spot.

One aspect of the present invention provides a spray head coupler for concentrating an aerosol spray from a nozzle of an aerosol container, the spray head coupler comprising: a hollow tube adapted to fit within an opening in the nozzle; and a collar coupled to said hollow tube, said collar being capable of holding the hollow tube in place when said aerosol is expelled from said aerosol container.

In alternate embodiments, the collar may further comprise a fixed arc disposed opposite said opening in the nozzle. The fixed arc may have an inside radius of curvature that is larger than a radius of said nozzle. The fixed arc may form part of a rear member of said collar, said rear member being coupled to said anchor proximate a left and right end of said anchor.

In some embodiments, the collar may further comprise an anchor coupled to said hollow tube such that a portion of said hollow tube extends through said anchor into said opening. The anchor may further comprise an adjustment handle at each end.

In some embodiments, the collar may comprise a flexible material such that squeezing opposite ends of said anchor allows the collar to open, thus facilitating attachment of the collar and flexible tube to the nozzle. The flexible material may be plastic. The collar may be integrally formed from a plastic material. Alternately, the collar and the hollow tube may be integrally formed from a plastic material.

An alternate aspect of the present invention provides a spray head coupler for concentrating an aerosol spray from a nozzle of an aerosol container, the spray head coupler comprising: a flexible collar capable of being coupled to said nozzle and adapted to hold a hollow tube for directing said aerosol spray such that said hollow tube is held in place when said aerosol spray is expelled from said aerosol container.

In some embodiments, the collar may further comprise a fixed arc disposed opposite an opening in the nozzle. The fixed arc may have an inside radius of curvature that is larger than a radius of said nozzle. The fixed arc may form part of a rear member of said collar, said rear member being coupled to said anchor proximate a left and right end of said anchor.

In alternate embodiments, the collar may further comprise an anchor having a nozzle anchoring ring configured to fit snugly within an opening in said nozzle. The anchor may further comprises an adjustment handle at each end.

In other embodiments, the collar may comprise a flexible material such that squeezing opposite ends of said anchor allows the collar to open, thus facilitating attachment of the collar and flexible tube to the nozzle. The collar may be integrally formed from a plastic material.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1A is a schematic drawing of a top portion of a prior art aerosol spray can;

FIG. 1B is a schematic drawing of the detachment of the prior art long fine tubing from the nozzle shown in FIG. 1A;

FIG. 2A is a perspective view of one embodiment of a spray head coupler according to the present invention;

FIG. 2B illustrates another perspective view of the embodiment shown in FIG. 2A;

FIG. 3A illustrates a perspective view of the embodiment of FIGS. 2A and 2B when installed on a spray nozzle;

FIG. 3B illustrates a perspective view of the embodiment of FIG. 3A prior to installation on the spray nozzle;

FIG. 4A illustrates a top view of the spray head coupler of FIGS. 2-3;

FIG. 4B illustrates a side view of the spray head coupler of FIGS. 2-3;

FIG. 4C illustrates a front view of the spray head coupler of FIG. 4A taken along the line 4c-4c;

FIG. 4D illustrates a rear view of the spray head coupler of FIG. 4A taken along the line 4d-4d;

FIG. 4E illustrates a top cross-sectional view of the spray head coupler of FIG. 4A;

FIG. 4F illustrates a cross-sectional view of the spray head coupler in an installed position as shown in FIG. 3A;

FIG. 5A illustrates a top view of the embodiment shown in FIG. 3B prior to installation;

FIG. 5B illustrates a top view of the spray head coupler installed as shown in FIG. 3A;

FIG. 6A illustrates a perspective view of the spray head coupler of FIGS. 2-5 when attached to an aerosol spray can for shipment;

FIG. 6B illustrates the spray head coupler when detached from the aerosol spray can of FIG. 6A;

FIG. 6C illustrates a perspective view of the spray head coupler of FIGS. 2-6B in an installed position prior to use;

FIG. 7A illustrates a top view of an alternate embodiment of a spray head coupler;

FIG. 7B illustrates a rear view of the spray head coupler of FIG. 7A; and

FIG. 7C illustrates a side view of the spray head coupler of FIGS. 7A and 7B.

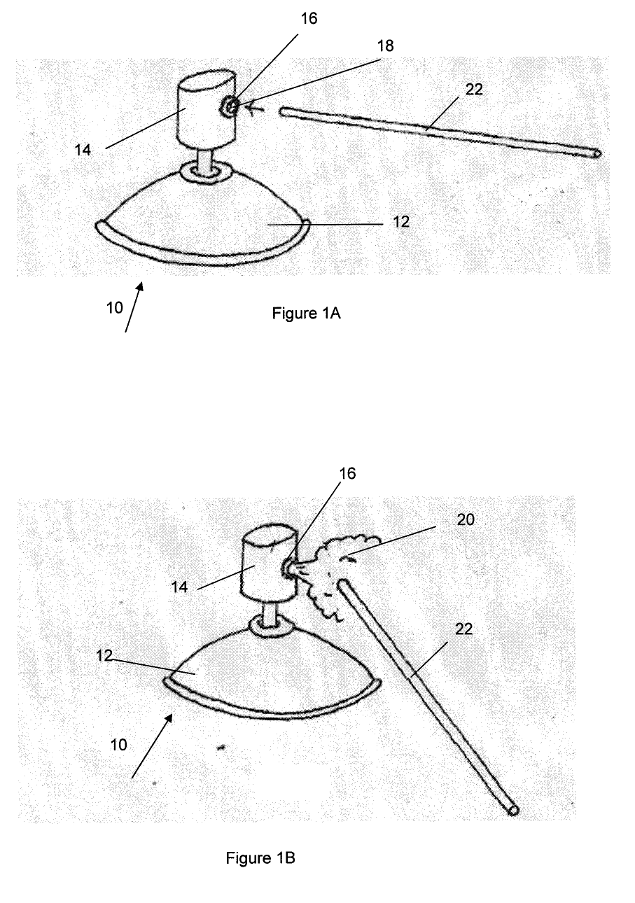

### DETAILED DESCRIPTION

The description below, together with the attached figures provides a more concrete explanation of the actual implementation details of this utility model.

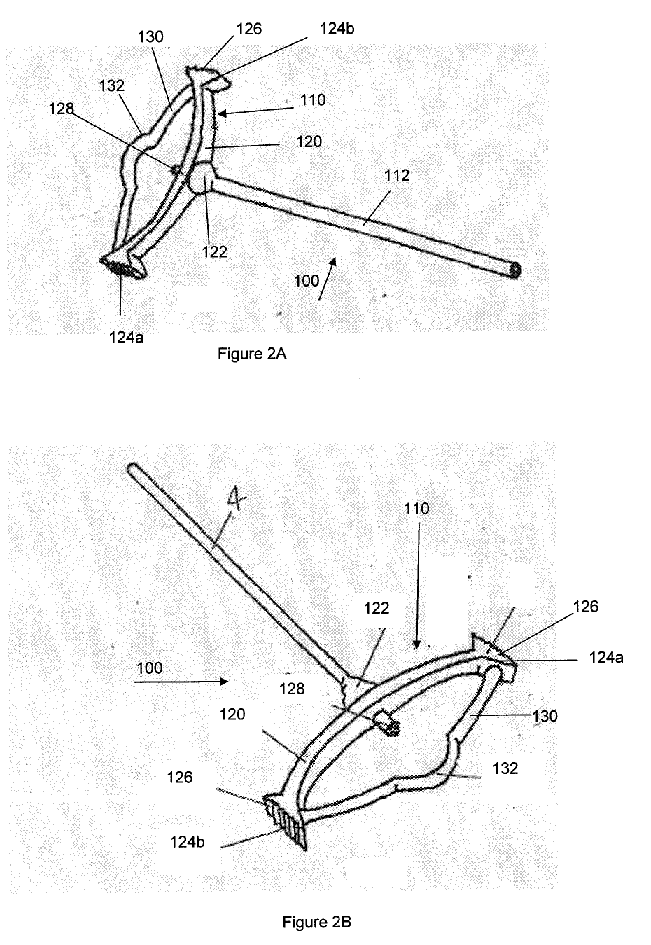

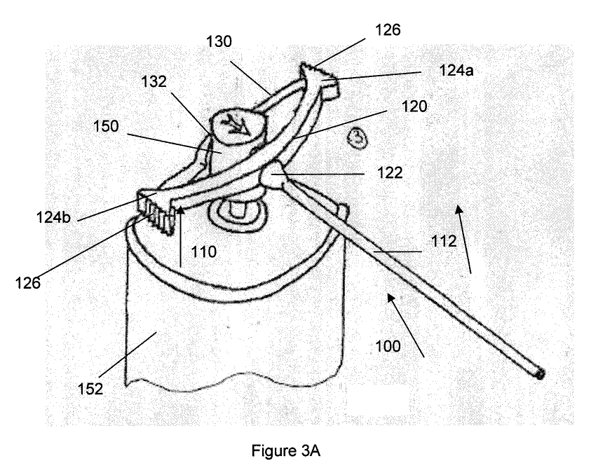

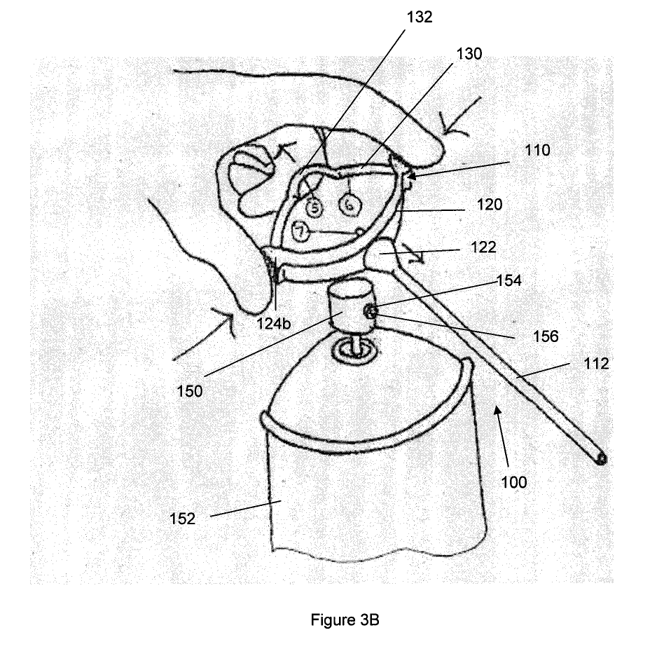

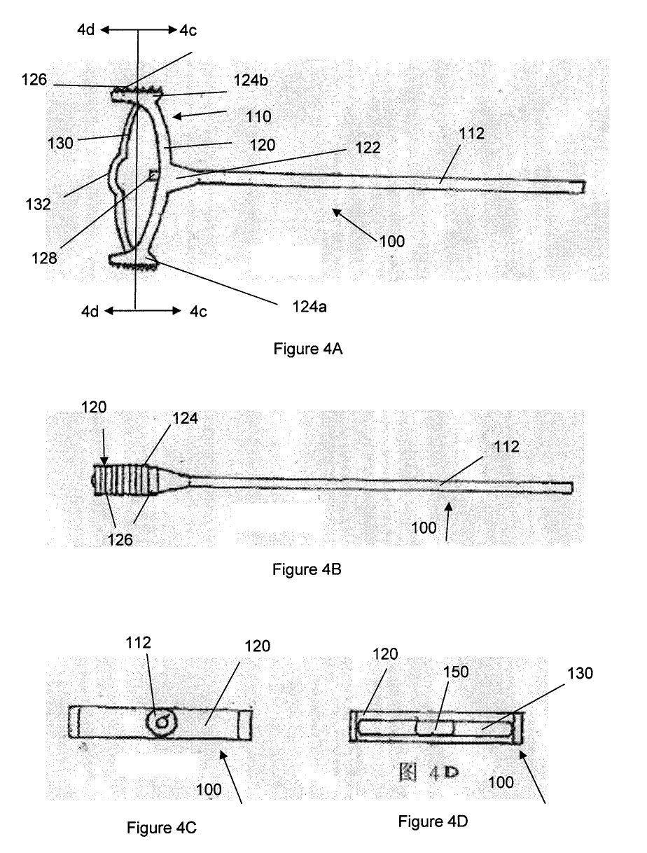

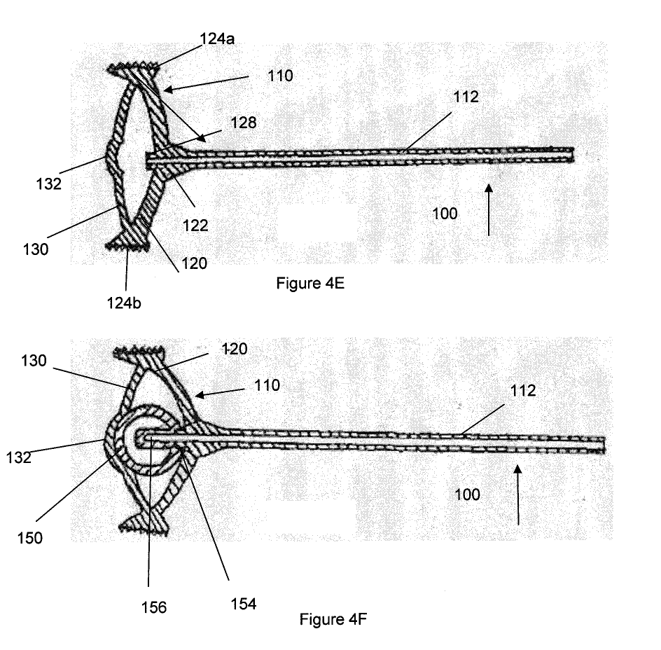

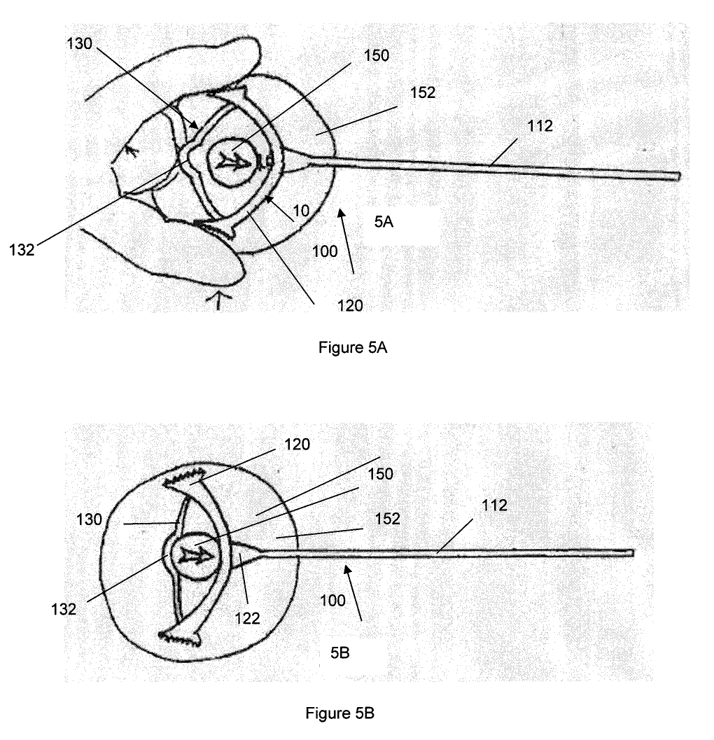

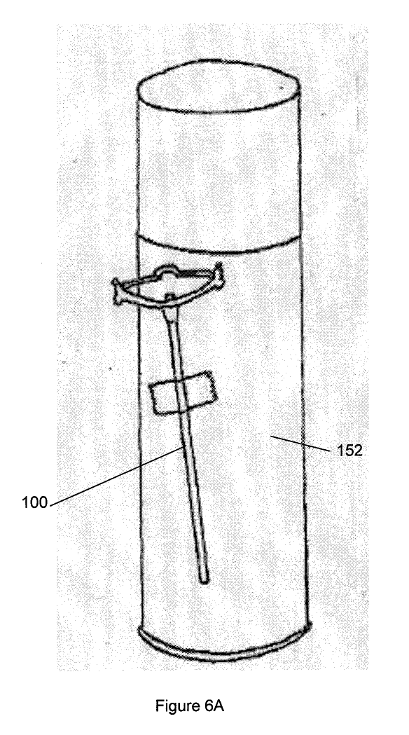

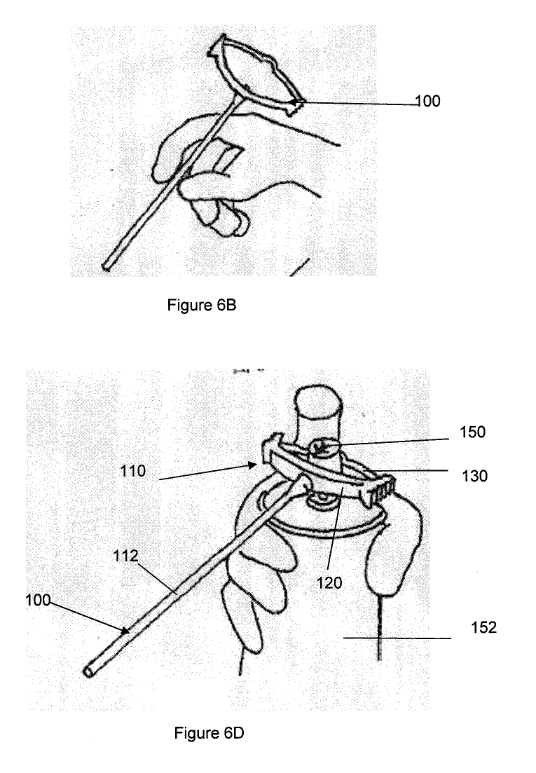

FIGS. 2-6 illustrate one embodiment of a spray head coupler 100 according to the present invention. The spray head coupler 100 is designed to attach to a nozzle 150 of an aerosol can 152 (see FIGS. 3, 5, and 6). The nozzle 152 includes an opening 154 having a small ejection port 156 in a center portion thereof. When the nozzle 150 is depressed, internal pressure within the aerosol spray can 152 ejects the aerosol through the ejection port 156.

The spray head coupler 100 includes a collar portion 110 which facilitates the attachment and removal of the spray head coupler 100 to/from the nozzle 150. The collar portion 110 includes an anchor portion 120 that may be coupled to a section of long fine tubing 112. The anchor 120 of the collar 110 may have an arced shape to facilitate easy installation and removal of the spray head coupler 100. This will be discussed in more detail below. The collar 110 also includes a rear portion 130 coupled on either end to the anchor 120. In some embodiments, the rear portion 130 may further include a fixed arc 132 that assists in preventing the spray head coupler 100 from detaching from the nozzle 150 when the nozzle 150 is depressed.

In some embodiments, the anchor 120 may include an anchoring ring or support 122 located in the center to provide support to the flexible tubing 112. The anchor 120 may also include adjustment handles 124a, 124b located on either end. When a user squeezes the adjustment handles 124a, 124b, the anchor 120 and rear portion 130 may flex to allow for the easy installation of the spray head coupler 100 onto the nozzle 150. In some embodiments, the adjustment handles may include grooves 126 that facilitate an easy grip for the user. The anchor 120 may also include a hollow nozzle anchoring ring 128 that projects inwardly from the anchor. The nozzle anchoring ring 128 may be sized to fit snugly within the opening 154 in the nozzle 150. In combination, the nozzle anchoring ring 128 and flexible tubing 112 concentrate the aerosol spray from the aerosol can 152 as directed by the user.

In some embodiments, the spray head coupler 100 may be made from a unitary piece of various types of flexible plastic materials known to those of skill in the art. The spray head coupler 100 may be produced using, by way of example and not limitation, an injection molding process known to those of skill in the art. In alternate embodiments, the collar 110 may be produced as a unitary piece of plastic. The flexible tube 112 may then be added at a later stage.

To attach the spray head coupler 100 to a nozzle 150 of an aerosol can 152, a user pinches the adjustment handles 124a, 124b of the anchor 120 on both ends, causing the arc-shaped anchor 120 to expand in the middle. The nozzle anchoring ring 128 is inserted into the opening 154 in the nozzle. Once the anchor 120 is installed on the spray nozzle 150, and pressure from the hand is released, the anchor 120 returns to the original eye-shape, allowing the anchor 120 to be securely attached to the nozzle 150. The fixed arc 132 in the rear portion 130 of the collar 110 assists in holding the spray head coupler 100 securely to the nozzle 150.

When the spray head coupler 100 is not in use, or to facilitate easy shipping, the spray head coupler may be detached from the nozzle 150 and fixed to the walls of the spray can 152 using, for example, adhesive tape. It is understood that other methods and devices may also be used to attach the spray head coupler 100 to the aerosol container 152 when not in use.

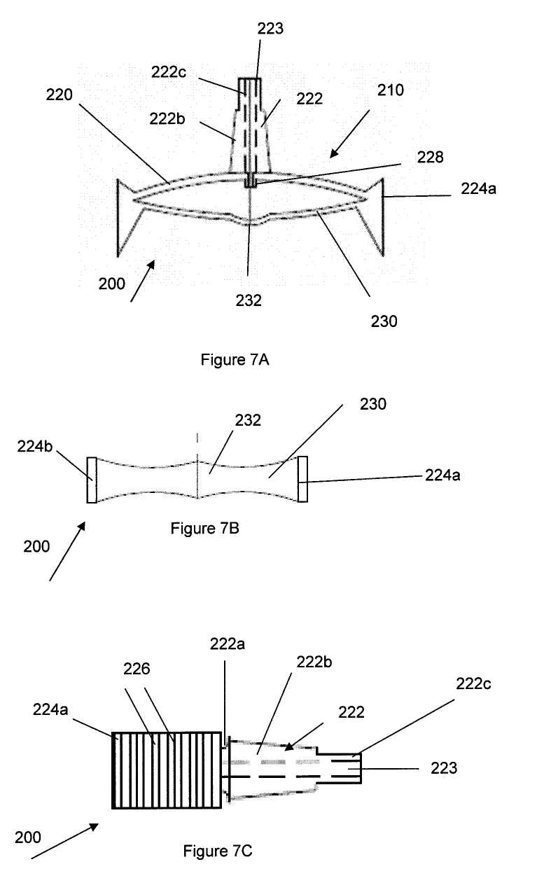

An alternate embodiment of a spray head coupler 200 is illustrated in FIGS. 7a-7c. FIG. 7a shows a top view of the spray head coupler 200. FIG. 7b illustrates a rear view of the spray head coupler 200 of FIG. 7a. FIG. 7c illustrates a side view of the spray head coupler 200 of FIGS. 7a and 7b. The spray head coupler 200 includes a collar portion 210 which facilitates the attachment and removal of the spray head coupler 200 to/from the nozzle 150. The collar portion 210 includes an anchor portion 220. As with the spray head coupler 100, the anchor 220 of the collar 210 may have an arced shape to facilitate easy installation and removal of the spray head coupler 200. The collar 210 also includes a rear portion 230 coupled on either end to the anchor 220. In some embodiments, the rear portion 230 may further include a fixed arc 232 that assists in preventing the spray head coupler 200 from detaching from the nozzle 150 when the nozzle 150 is depressed.

In some embodiments, the anchor 220 may include an anchoring ring or support 222 located in the center. The anchoring ring 222 may be used to provide to the flexible tubing 112 (FIG. 2). In this embodiment, the support 222 may include a connecting portion 222a, a main body 222b, and a tube support portion 222c. The flexible tubing 112 may be inserted into a corresponding round opening 223 in the tube support portion 222c. While the embodiment of the spray head coupler 200 shown in FIGS. 7a-7c illustrates the main body 222b of the anchoring ring 222 having a conical cross-section, it is understood that other cross-sectional shapes may also be used. Similarly, while the embodiment of the spray head coupler 200 shown in FIGS. 7a-7c illustrates the tube support portion 222c as having a substantially round cross section, it is understood that other cross-sectional shapes may be used depending on the shape of the flexible tubing 112. A spray head coupler having any shape anchoring ring 222 and flexible tubing 112 is therefore deemed to fall within the scope of the embodiments of the present invention.

The anchor 220 may also include adjustment handles 224a, 224b located on either end. When a user squeezes the adjustment handles 224a, 224b, the anchor 220 and rear portion 230 may flex to allow for the easy installation of the spray head coupler 200 onto the nozzle 150. In some embodiments, the adjustment handles 224a, 224b may include grooves 226 that facilitate an easy grip for the user. The anchor 220 may also include a hollow nozzle anchoring ring 228 that projects inwardly from the anchor 220. The nozzle anchoring ring 228 may be sized to fit snugly within the opening 154 in the nozzle 150. In combination, the nozzle anchoring ring 228 and flexible tubing 112 inserted in the anchoring ring 222 may concentrate the aerosol spray from the aerosol can 152 as directed by the user.

Embodiments of the present invention provide several advantages over the prior art. The spray head coupler helps to prevent the tube from being expelled from the nozzle when the aerosol is expelled from the container. The spray head coupler is easy to use, and may be used over and over again on multiple nozzles.

The above description illustrates the advantages of this utility model, and does not pose any restrictions to the structure of this utility model in any way. Any simple adjustments to the implementation details that are based on the technical qualities of this utility model, or similar modifications, are considered to be within the scope of the technical plan of this utility model.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A spray head coupler for concentrating an aerosol spray from a nozzle of an aerosol container, the spray head coupler comprising:
a hollow tube adapted to fit within an opening in the nozzle; and
a flexible collar comprising;
an anchor; and
a rear member coupled to said anchor proximate a left and right end of said anchor; wherein
a portion of said hollow tube extends through said anchor into said opening, such that said collar is capable of holding the hollow tube in place when said aerosol is expelled from said aerosol container.

2. The spray head coupler of claim 1, wherein said collar further comprises a fixed arc disposed in said rear member opposite said opening in the nozzle.

3. The spray head coupler of claim 2, wherein said fixed arc has an inside radius of curvature that is larger than a radius of said nozzle.

4. (canceled)

5. (canceled)

6. The spray head coupler of claim 1, wherein said anchor further comprises an adjustment handle at each end.

7. The spray head coupler of claim 1, wherein squeezing opposite ends of said anchor allows the collar to open, thus facilitating attachment of the collar and flexible tube to the nozzle.

8. The spray head coupler of claim 1, wherein said collar comprises a flexible plastic material.

9. The spray head coupler of claim 1, wherein said collar is integrally formed from a plastic material.

10. The spray head coupler of claim 1, wherein said collar and said hollow tube are integrally formed from a plastic material.

11. A spray head coupler for concentrating an aerosol spray from a nozzle of an aerosol container, the spray head coupler comprising:
a flexible collar comprising an anchor and a rear member coupled to said anchor proximate a left and right end of said anchor; wherein
said collar is capable of being coupled to said nozzle; and
said anchor is adapted to hold a hollow tube for directing said aerosol spray such that said hollow tube is held in place on said nozzle when said aerosol spray is expelled from said aerosol container.

12. The spray head coupler of claim 11, wherein said further comprises a fixed arc disposed opposite an opening in the nozzle.

13. The spray head coupler of claim 12, wherein said fixed arc has an inside radius of curvature that is larger than a radius of said nozzle.

14. (canceled)

15. The spray head coupler of claim 11, wherein said anchor comprises a nozzle anchoring ring configured to fit snugly within an opening in said nozzle.

16. The spray head coupler of claim 15, wherein said anchor further comprises an adjustment handle at each end.

17. The spray head coupler of claim 15, wherein said collar comprises a flexible material such that squeezing opposite ends of said anchor allows the collar to open, thus facilitating attachment of the collar and flexible tube to the nozzle.

18. The spray head coupler of claim 11, wherein said collar is integrally formed from a plastic material.

19. The spray head coupler of claim 11, wherein said collar and said hollow tube are integrally formed from a plastic material.
